(19) United States
(12) Patent Application Publication
(10) Pub. No.: US 2015/0217212 A1
(43) Pub. Date: Aug. 6, 2015

(54) BREAKING FOAMS

(71) Applicant: SCHLUMBERGER TECHNOLOGY CORPORATION, Sugar Land, TX (US)

(72) Inventor: David Snoswell, Cambridge (GB)

(21) Appl. No.: 14/603,038

(22) Filed: Jan. 22, 2015

(30) Foreign Application Priority Data
Jan. 27, 2014 (GB) 1401322.1

(51) Int. Cl. B01D 19/02; B01D 19/00

(52) U.S. Cl. CPC B01D 19/02; B01D 19/0073

(57) ABSTRACT

A method of breaking a foam is to direct a laser beam into the foam. The laser beam(s) may be scanned across a conduit in which the foam is travelling. The foam may be formed from gas and liquid produced from a hydrocarbon reservoir.

### CROSS-REFERENCE TO RELATED APPLICATION

This application claims priority to British Application No GB1401322.1 filed on 27 Jan. 2014, which is incorporated herein by reference in its entirety.

### BACKGROUND

A wet foam (i.e. a mass of bubbles) may be formed at the surface of a quantity of liquid so that there is a continuous liquid phase below the foam and a continuous gaseous phase above the foam. However, when foam is formed in a pipe or other conduit or is formed in an enclosed vessel, the foam may occupy so much of the flow cross-section or so much of the volume of the enclosing vessel that any continuous gas phase or any continuous liquid phase is small or absent.

The occurrence of foams can be an unwanted inconvenience in a diverse range of industrial processes. Excessive foam can cause a range of problems, particularly in relation to mechanical factors, coolants and processing liquids. These problems include reductions in pump efficiency and storage tank capacity, drainage issues within filtration systems, and associated costs related to the time required to cease production and remove foam.

Foam formation can occur when liquid phase contains a substance which is surface active. This may be a surfactant which has intentionally been included in the liquid phase, or it may be a material which happens to be present in the liquid phase and has some surface activity. Structurally, a wet foam consists of thin lamellae of the surfactant loaded liquid in a three-dimensional structure.

Foam is sometimes controlled by deliberate addition of a chemical which inhibits foam formation. Such a chemical may be referred to as an anti-foam or a defoamer. However, this addition of an extra chemical is an added cost and may not always be possible. Industries in which foam control is required include the oil industry, one instance being at oil rigs during wellbore cleaning operations. Currently, chemical defoamers may be used to break foams at oil rigs. Chemical defoamers are also used in many other industrial processes and products, including wood pulp, paper, paint, industrial wastewater treatment and food processing. Such applications include floatation deinking, foam control in printing, aerators for sewage treatment and fermentation.

### SUMMARY

This summary is provided to introduce a selection of concepts that are further described below. This summary is not intended to be used as an aid in limiting the scope of the subject matter claimed.

In contrast with prior methods involving the use of chemical defoamers, the present invention instead relies on breaking foam by directing the beam of a laser into the foam. A laser beam comprises light travelling along parallel paths within the cross section of the beam, so that there is little or no spreading of the beam, although a laser beam may be focussed by a lens, curved mirror or other optical element so as to bring it to a smaller cross section, sometimes referred to as a waist, after which it may spread. Without wishing to be bound by theory, we believe that the high energy density within a small cross section, which is characteristic of a laser beam, leads to rapid heating of a small area of a foam lamella when a laser beam intersects the lamella. This localised heating destabilises or ruptures the lamella, possibly through vaporising a very small quantity of the liquid within the lamella, and thus breaks a bubble of the foam (or merges two adjacent bubbles into one larger bubble which may then be broken by the laser beam striking another lamella).

In some embodiments of the invention, foam is broken as it passes along a conduit. The conduit may have a section in which one or more laser beams are directed into the foam, and the beam or beams may be arranged to scan across the cross-section of the conduit. This may allow the foam to be broken in a continuous process without the use of chemical additives. Breaking a foam can assist the separation of gas and liquid and separated gas and liquid may leave the conduit by separate exits.

One of the features of breaking a foam in this way is that there may be little or no chemical change in the overall composition which may not be the case when using chemical additives. A consequence is that the breakage of the foam can be reversible. The foam could be reformed by agitation or aeration should there be a need to do so.

When foam is broken in a conduit, the foam may be made to pass through a labyrinth positioned in the conduit upstream of a section in which a laser beam or beams are directed at the foam, in order to block any leakage of laser light. The constituents of the broken foam may pass through a labyrinth positioned downstream of such a section, so as to block any leakage of laser light in this downstream direction. A labyrinth may consist of two or more parts located internally in the conduit, serving to interrupt any straight line along the conduit and causing flow in the conduit to change direction as it passes through the labyrinth. An alternative to locating a labyrinth within a conduit is to provide turns in the conduit so as to block straight lines out of the section with the laser beam or beams.

Also disclosed here is apparatus comprising a flow path or enclosure for fluid, having a section equipped with one or more lasers positioned to direct a laser beam into the flow path or enclosure, to rupture foam therein.

### BRIEF DESCRIPTION OF THE DRAWINGS

FIG. 1 is a schematic view of the interior of a portion of a conduit including a section in which foam is broken by laser beams;

FIG. 2 is a cross section on line II-II of FIG. 1;

FIG. 3 is a schematic illustration of a scanning laser unit;

FIG. 4 is a view similar to FIG. 1, showing a modified arrangement;

FIG. 5 is a schematic plan view of experimental apparatus; and

FIG. 6 is a schematic elevational view.

### DETAILED DESCRIPTION

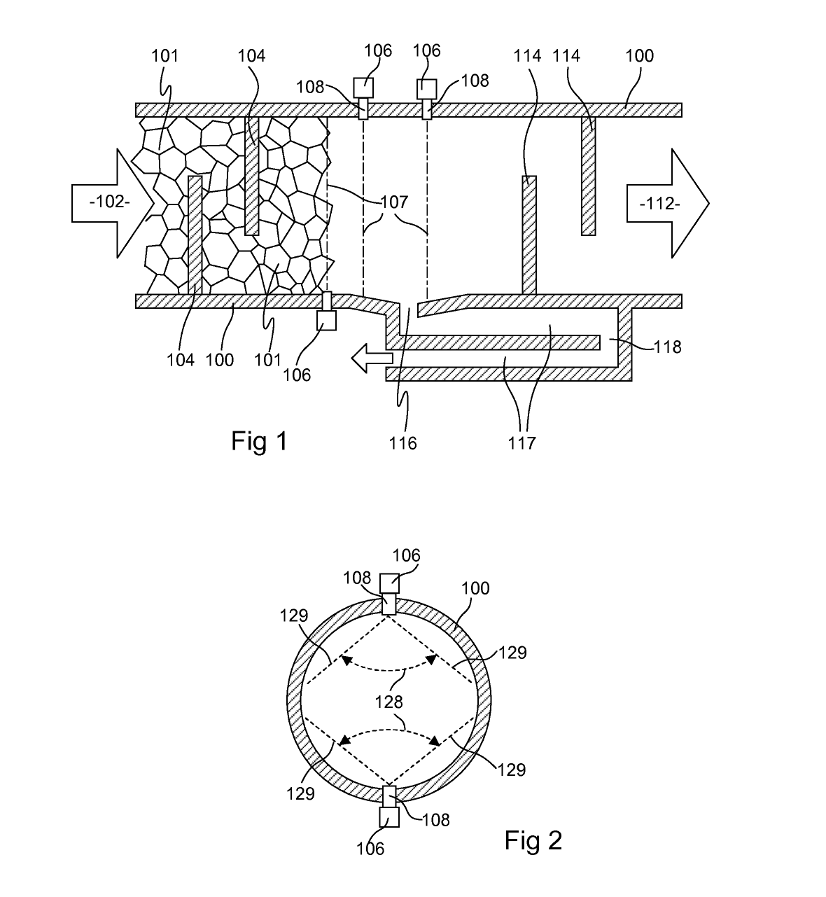

FIGS. 1 and 2 diagrammatically illustrate an embodiment of a system in which a continuous flow of wet foam is broken by scanning laser beams. The diagram shows foam 101 flowing along a conduit 100 in the direction indicated by arrow 102, i.e. from left to right as illustrated. The foam 101 passes through a labyrinth formed by plates 104 within the conduit 100. These plates 104 extend part way across the cross section of the conduit, blocking the path of any scattered laser light and so prevent leakage of laser light into the upstream pipework. The foam is of course compelled to change its direction of flow as it passes over one plate and under the next.

The foam then enters a section of the conduit in which laser units 106 (each comprising a laser and optics to manipulate the laser beam) direct laser beams 107 (shown as chain lines) through windows 108 and across the conduit 100. As illustrated by FIG. 2, the laser beams 107 are repeatedly scanned to and fro across an arc 128 transverse to the conduit 100. The edges of the arcs are indicated 129. The width of each arc 128 is such that the entire cross section of the conduit is scanned by at least one beam 107. It is believed that the high energy density within a small cross section, which is characteristic of a laser beam, leads to rapid heating of a small area of a foam lamella when a laser beam intersects the lamella. This localised heating ruptures the lamella, possibly through vaporising a very small quantity of the liquid within the lamella, and thus breaks the bubble of foam bounded by that lamella.

Arrangements for scanning a laser beam across an arc as shown by FIG. 2 are well-known. It can be done by moving the laser itself, but it is common to keep the laser fixed and use optical elements such as a mirror or prism to deflect the beam.

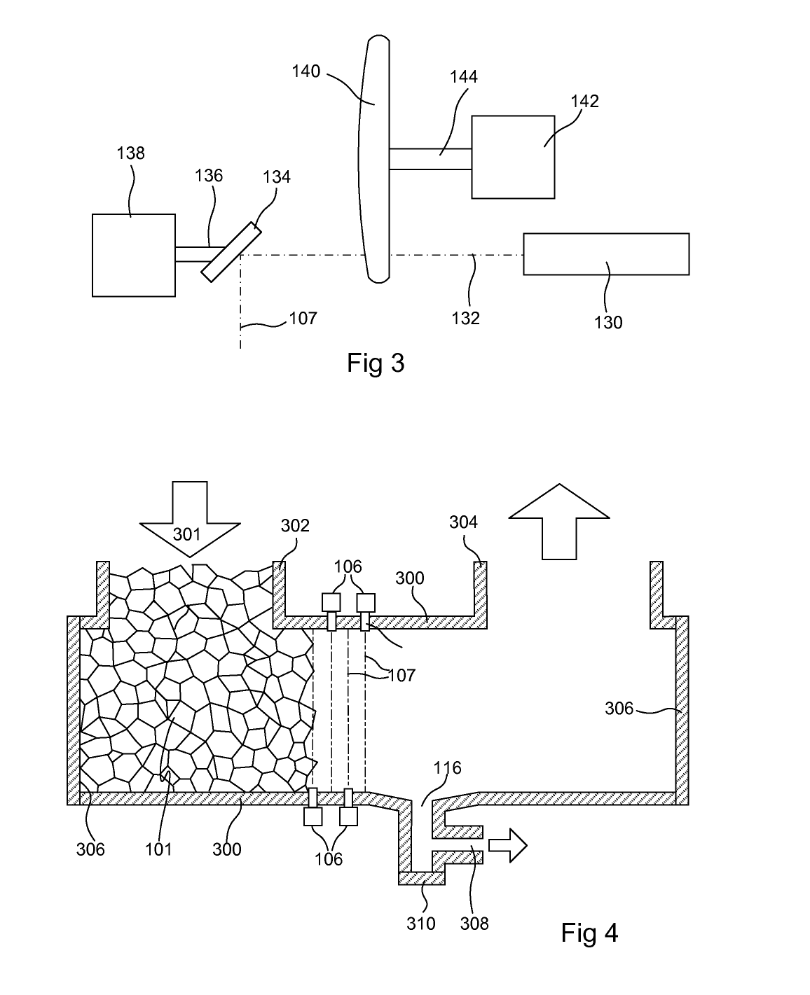

FIG. 3 illustrates, by way of example, a possible arrangement. Fixed laser 130 directs its beam 132 onto a 45° mirror 134. This mirror is attached to the shaft 136 of a stepper motor 138 which is operated to twist the mirror through an arc around the axis of shaft 136. The result is that the output beam 107 is scanned in a plane which is transverse to the plane of the diagram. A unit as shown in FIG. 3 would be fitted to the conduit 100 in an orientation such that the scan plane of the output beam 107 is transverse to the conduit 100.

As a result of the foam being broken, gas and liquid in the conduit are able to separate. The separated gas continues to flow along the conduit 100 as indicated by arrow 112. It passes through a labyrinth formed by two more plates 114 which prevent leakage of laser light into the downstream pipework. Separated liquid drains through an outlet 116 and passes along an outlet pipe 117 which doubles back at 118 so as to block the path of any scattered laser light.

An arrangement as shown and described above may be implemented with lasers having sufficient power that the parallel beam output from the laser can rupture a lamella in the foam. However, another possibility is to focus the laser beam to a so-called waist of reduced cross-section. In this event it may be desirable to arrange for the position of this waist to move to and fro across the cross-section of the conduit 100 while scanning the laser beam. One possible arrangement for this is included in FIG. 3. The laser beam 132 passes through a focusing lens 140. This lens 140 has both spherical and cylindrical curvature so that its focal length is not uniform. The lens 140 is attached to the shaft 144 of a stepper motor 142 and is rotated continuously by this motor 142 so that the focal length where beam 132 passes through the periphery of the lens 140 varies. Consequently the waist to which the beam is reduced moves between two points corresponding to the maximum and minimum focal lengths. The curvatures of the lens 140 are chosen so that these two points are near to the wall of the conduit 100 when the laser beam extends diametrically across the conduit.

FIG. 4 shows a modified arrangement of conduit. Foam 101 entering in the direction indicated by arrow 301 travels along a conduit 300 which includes a section in which scanning laser units 106 direct their beams 107 into the foam in the conduit, thus breaking the foam just as with the arrangement of FIG. 1. Separated gas continues to flow along the conduit and separated liquid drains to outlet 116. However, internal baffles 104 and 114 are not used. The inlet 302 for foam and the outlet 304 for gas are each constructed as a blind tee, so that scattered laser light (if any) will be blocked by striking the flat end walls 306. The outlet pipe 308 for liquid also connects to the outlet 116 at a blind tee with end wall 310.

The above description has presumed that the flow along the conduits 100 or 300 has filled the conduit with foam. However, the same arrangement could be used when the foam occupies only part of the cross section of the conduit, or occurs intermittently rather than continuously.

### Experimental Work

Experiments were carried out to demonstrate the efficacy of a laser beam for breaking foam. These experiments were carried out using apparatus marketed as a laser cutter to direct a laser beam onto foam in an open topped Petri dish.

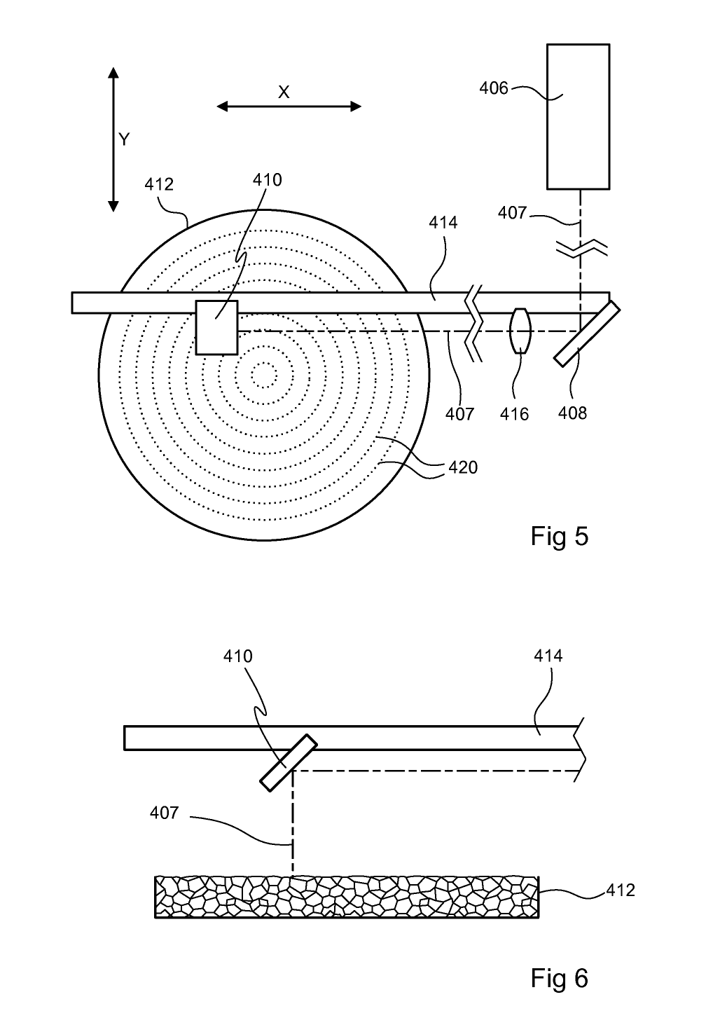

The experimental setup is shown by FIGS. 5 and 6. The beam 407 from a fixed laser 406 was directed by mirror 408 onto a mirror 410 which directed the laser beam down onto the open top of the Petri dish 412 containing foam. The mirror 408 was at one end of a carriage 414 movable to and fro in the horizontal direction indicated by arrow X and the mirror 410 was movable to and fro on the carriage 414 in the in the orthogonal horizontal direction indicated by arrow Y. Computer-controlled movement of the carriage 414 and movement of the mirror 410 on the carriage 414 enabled the mirror 410 and hence the point at which the laser beam was directed downwardly to be positioned freely within a working area in a manner similar to the motion of the print head of a dot matrix printer.

The laser 406 was a 35 watt carbon dioxide laser and its output could be adjusted from 10% to 100% of full power. It emitted a beam at a wavelength of 10.5 microns and the light path included a converging lens 416 to focus the laser beam down to a cross section of about 0.5 mm².

For each experiment a model foam was made from a solution of 0.67 wt % sodium dodecyl sulphate and 48.2 wt % glycerol in high purity water. This solution was placed in a bottle and shaken vigorously to form a foam. The presence of glycerol in the liquid phase gave a very stable foam which, if left undisturbed, remained intact for over 30 min. A quantity of this foam was scooped into a Petri dish with a spatula and levelled off so that the dish was filled to its top with foam. The Petri-dish had internal diameter 88 mm and depth 13 mm, so that it held 79 ml of foam.

The dish was then placed in the laser cutter in the path of the laser beam as shown in FIGS. 5 and 6 and this apparatus was operated to move the beam over the foam in a series of concentric circles 418 (shown dotted in FIG. 5). The circles were spaced apart by 4 mm. This spacing of 4 mm was chosen because in preliminary experiments it had been found that spacing greater than 5 mm left some of the foam intact and unaffected by the laser beam. The time for moving the laser beam in this pattern of concentric circles 418 was 205 seconds in some experiments and 32.5 seconds in other experiments.

In order to check that any collapse of foam was brought about by the laser beam rather than by any other cause, a preliminary experiment was carried out in accordance with the above procedure but with the laser switched off. The foam was observed to remain intact.

In each experiment, after the foam had been exposed to the laser a photograph of the Petri dish was taken and the reduction in foam height was determined from the photo by means of image analysis software using the known height of the Petri dish as a calibration scale. This determination had an estimated error of 10% but was sufficient to observe variation with power of the laser beam.

For the first five experiments designated A to E in the table below, the Petri dish was positioned so that the laser beam came to its narrowest focus 2 mm below the top of the Petri dish. The foam was thus exposed to a well-focussed beam. Two further experiments designated F and G were carried out with the Petri dish positioned so that the laser beam came to its narrowest focus at a point deeper in the foam, 9 mm below the top of the Petri dish. Results obtained are set out in the following table:

| | | | Laser focus | Drop in | Volume of | | Joules per |
|---|---|---|---|---|---|---|---|
| | Laser Power | Laser Speed | (mm below | foam height | foam burst | Laser Energy | volume burst |
| | (Watt) | (mm/sec) | top of dish) | (mm) | (mL) | (Joules) | (J/L) |
| A | 28 | 67.5 | 2 | 9 | 55 | 574 | 10486 |
| B | 14 | 67.5 | 2 | 6.5 | 40 | 287 | 7260 |
| C | 7 | 67.5 | 2 | 5.5 | 33 | 144 | 4290 |
| D | 7 | 42.5 | 2 | 8 | 49 | 228 | 4676 |
| E | 3.5 | 42.5 | 2 | 4.5 | 27 | 114 | 4156 |
| F | 3.5 | 42.5 | 9 | 8 | 49 | 114 | 2338 |
| G | 3.5 | 42.5 | 9 | 5 | 30 | 114 | 3740 |

These experimental results demonstrate that a low-powered laser beam, brought to a focus within a foam is able to rupture lamellae within the foam and thus break or reduce the foam.

It will be appreciated that the example embodiments described above can be modified and varied within the scope of the concepts which they exemplify. Features referred to above or shown in individual embodiments above may be used together in any combination as well as those which have been shown and described specifically. Accordingly, all such modifications are intended to be included within the scope of this disclosure as defined in the following claims.

1. A method of breaking a foam, comprising directing the beam of at least one laser into the foam.

2. A method according to claim 1 wherein the beam of the at least one laser is repeatedly scanned across a space to break foam in that space.

3. A method according to claim 1 wherein the beams of multiple lasers are directed into the foam from different positions.

4. A method according to claim 1 wherein the foam is travelling along and enclosed within a conduit.

5. A method according to claim 4 wherein the beams of multiple lasers are directed into the foam from a plurality of positions distributed around the periphery of the conduit and each beam is repeatedly scanned across at least part of the cross section of the conduit.

6. A method according to claim 4 wherein the conduit comprises a section in which the beam of the at least one laser is directed into the foam, and the conduit is configured.

7. A method according to claim 6 wherein the conduit contains internal elements positioned to block the path of any light transmitted along the conduit from the said section.

8. A method according to claim 1 further comprising separating gas and liquid from the broken foam and directing the separated gas and liquid along separate flow paths.

9. A method according to claim 1 wherein the foam comprises gaseous and liquid hydrocarbons flowing from an underground hydrocarbon reservoir.

10. Apparatus comprising a flow path or enclosure for fluid, having a section equipped with one or more lasers positioned to direct a laser beam into the flow path or enclosure, to rupture foam therein.

11. Apparatus according to claim 10 further comprising means for pumping fluid along the flow path or into and out of the enclosure.
